(19) United States
(12) Patent Application Publication
(10) Pub. No.: US 2026/0267175 A1
(43) Pub. Date: Sep. 10, 2026

(54) HYBRID MODE MULTIPLEXING OPTICAL MODULATOR

(71) Applicant: HyperLight Corporation, Cambridge, MA (US)

(72) Inventors: Jeffrey Cole Holzgrafe, Lexington, MA (US); Christian Reimer, Wellesley, MA (US)

(21) Appl. No.: 19/548,869

(22) Filed: Feb. 24, 2026

Related U.S. Application Data
(60) Provisional application No. 63/763,145, filed on Feb. 25, 2025.

(51) Int. Cl. G02F 1/035; G02F 1/03

(52) U.S. Cl. CPC G02F 1/035; G02F 1/0311; G02F 1/0327; G02F 2201/16; G02F 2202/20; G02F 2203/50

(57) ABSTRACT

An optical modulator including at least one electrode and a waveguide is described. The waveguide includes a mode multiplexer, a modulation section, and a mode converting reflector. The modulation section is between and proximate to a portion of the electrode(s). The modulation section is in an optical path between the mode multiplexer and the mode converting reflector. The mode multiplexer is configured to propagate a first mode from a first waveguide arm to the modulation section, to receive a second mode from the modulation section, and to provide the first mode to a second waveguide arm from the second mode received from the modulation section. The mode converting reflector is configured to receive the first mode from the modulation section and to propagate the second mode back through the modulation section.

### CROSS REFERENCE TO OTHER APPLICATIONS

This application claims priority to U.S. Provisional Patent Application No. 63/763,145 entitled MODE MULTIPLEXING OPTICAL MODULATOR filed Feb. 25, 2025 which is incorporated herein by reference for all purposes.

### BACKGROUND OF THE INVENTION

Lithium-containing (LC) electro-optic materials, such as lithium niobate (LN) and/or lithium tantalate (LT), are of interest for use in applications such as high speed optical devices. Thin film LC (TFLC) optical devices may support high data rates and low losses, which is desirable in applications such as data communication and/or telecommunication. TFLC optical devices may also exhibit a large electro-optic effect. However, TFLC modulators are typically long. As a result, the photonics integrated circuit (PIC) incorporating such modulator(s) may also be large in comparison to other integrated circuits (ICs). Packaging of PICs incorporating TFLC modulators may thus be more complex. Therefore, techniques for improving packaging of TFLC modulators may be desired.

### BRIEF DESCRIPTION OF THE DRAWINGS

Various embodiments of the invention are disclosed in the following detailed description and the accompanying drawings.

FIGS. 1A-1B are block diagram of embodiments of thin film lithium-containing optical devices.

FIGS. 2A-2B are block diagram of embodiments of thin film lithium-containing optical devices.

FIGS. 3A-3C are diagrams of an embodiment of a thin film lithium-containing optical device.

FIGS. 4A-4C are diagrams of an embodiment of a thin film lithium-containing optical device.

FIGS. 5A-5C are diagrams of an embodiment of a thin film lithium-containing optical device.

FIG. 6 is a diagram of an embodiment of a thin film lithium-containing optical device.

FIG. 7 is a diagram of an embodiment of a thin film lithium-containing optical device.

FIG. 8 is a diagram depicting the response of an embodiment of a thin film lithium-containing optical device.

FIG. 9 is a flow chart depicting an embodiment of a method for providing a compact thin film lithium-containing optical device.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Lithium-containing (LC) electro-optic materials, such as lithium niobate (LN) and/or lithium tantalate (LT), are of interest for use in applications such as high speed optical devices. Thin film LC (TFLC) optical devices may be desired for use as electro-optic optical modulators applications such as data communication and/or telecommunication. TFLC optical devices may also exhibit a large electro-optic effect, which may allow for a lower V-pi (voltage required to provide a phase shift of pi). However, TFLC modulators are typically long. For example, TFLC modulators may be on the order of one centimeter for a 2V V-pi. Some TFLC modulators may be longer. The photonics integrated circuit (PIC) incorporating such modulator(s) may also be large in comparison to other integrated circuits (ICs) in order to accommodate the length of the TFLC modulator(s). The large size of such PICs may complicate packaging of the PICs. For example, three-dimensional (3D) packaging of TFLC PICs may be challenging.

To achieve a more compact electro-optic modulator, a traveling-wave Michelson electro-optic modulator configuration may be used instead of a Mach–Zehnder topology. However, Michelson modulators suffer from serious issues. Michelson modulators may have a high optical return loss, which is undesirable. For example, Michelson modulators may be subject to optical-reflection based inter-symbol interference in optical communication applications. As a result, the optical signal may be significantly noisier than desired. The electro-optic frequency response of traveling wave devices is often poor. This may be due to poorly controlled group delay matching between the optical and electrical reflections. Stated differently, velocity matching between the electrode signal (e.g., the RF signal) and the optical signal may be challenging at certain frequencies. Consequently, the performance of such modulators may be poorer than desired. Accordingly, techniques for improving optical devices incorporating TFLC optical components may be desired.

An optical modulator including at least one electrode and a waveguide is described. The waveguide includes a mode multiplexer, a modulation section, and a mode converting reflector. The modulation section is between and proximate to a portion of the electrode(s). The modulation section is in an optical path between the mode multiplexer and the mode converting reflector. The mode multiplexer is configured to propagate a first mode from a first waveguide arm to the modulation section, to receive a second mode from the modulation section, and to provide the first mode to a second waveguide arm from the second mode received from the modulation section. The mode converting reflector is configured to receive the first mode from the modulation section and to propagate the second mode back through the modulation section. The first and second modes may be traveling wave modes. Thus, the optical modulator may be a traveling wave modulator.

In some embodiments, the waveguide includes an additional mode multiplexer, an additional modulation section, and an additional mode converting reflector. The additional modulation section is positioned between and proximate to an additional portion of the electrode(s). Moreover, the additional modulation section is located in an additional optical path between the additional mode multiplexer and the additional mode converting reflector. The additional mode multiplexer is configured to propagate a third mode from a third waveguide arm to the additional modulation section, to receive a fourth mode from the additional modulation section, and to provide the third mode to a fourth waveguide arm based on the fourth mode received from the additional modulation section. The additional mode converting reflector is configured to receive the third mode from the additional modulation section and to propagate the fourth mode back through the additional modulation section.

In some embodiments, the optical modulator further includes a splitter and a combiner. The splitter splits an input optical signal into the first mode in the first waveguide arm and the third mode in the third waveguide arm. The combiner combines the second mode of the second waveguide arm with the fourth mode of the fourth waveguide arm. In some embodiments, the first mode and the third mode are TE0 modes, while the second mode and the fourth mode are TE1 modes.

In further embodiments, the waveguide includes a third mode multiplexer, a third modulation section, and a third mode converting reflector coupled with the second waveguide arm, as well as a fourth mode multiplexer, a fourth modulation section, and a fourth mode converting reflector coupled with the fourth waveguide arm. The third modulation section is positioned between and proximate to a third portion of the at least one electrode, and the fourth modulation section is positioned between and proximate to a fourth portion of the at least one electrode. The third mode multiplexer may propagate the first mode from the second waveguide arm to the third modulation section, receive the second mode from the third modulation section, and provide the first mode to a fifth waveguide arm based on the second mode received from the third modulation section. The third mode converting reflector may receive the first mode from the third modulation section and propagate the second mode back through the third modulation section to the third mode multiplexer. Similarly, the fourth mode multiplexer may propagate the first mode from the fourth waveguide arm to the fourth modulation section, receive the second mode from the fourth modulation section, and provide the first mode to a sixth waveguide arm based on the second mode received from the fourth modulation section. The fourth mode converting reflector is configured to receive the first mode from the fourth modulation section and to propagate the second mode back through the fourth modulation section to the fourth mode multiplexer.

In some embodiments, the optical modulator further includes an electrode signal delay matching section coupled with the electrode(s). The electrode signal delay matching section may be configured to reduce a velocity mismatch between an electrode signal and an optical signal that includes the first mode and the second mode. In some embodiments, the optical modulator includes an electrode signal filtering network coupled with the at least one electrode. In certain embodiments, the waveguide includes lithium. The mode multiplexer may be selected from an adiabatic mode multiplexer or a grating mode multiplexer.

In some embodiments, the optical modulator is a cascaded modulator including multiple stages. Each stage may include a mode multiplexer, a modulation section, and a mode converting reflector. In some embodiments, each stage has a length of at least one hundred micrometers and not more than one millimeter.

An optical device that includes an optical modulator is described. The optical modulator includes electrodes and a waveguide. The waveguide includes a mode multiplexer, at least one modulation section, and a mode converting reflector. The modulation section(s) are between and proximate to a portion of the electrodes and located in an optical path between the mode multiplexer and the mode converting reflector. The mode multiplexer is configured to propagate a first mode from a first waveguide arm to the modulation section(s), to receive a second mode from the modulation section(s), and to provide the first mode to a second waveguide arm based on the second mode received from the modulation section(s). The mode converting reflector receives the first mode from the modulation section(s) and to propagate the second mode back through the modulation section(s).

In some embodiments of the optical device, the waveguide further includes an additional mode multiplexer, at least one additional modulation section, and an additional mode converting reflector. The additional modulation section(s) are positioned between and proximate to an additional portion of the electrodes and located in an additional optical path between the additional mode multiplexer and the additional mode converting reflector. The additional mode multiplexer may be configured to propagate a third mode from a third waveguide arm to the additional modulation section(s), to receive a fourth mode from the additional modulation section(s), and to provide the third mode to a fourth waveguide arm based on the fourth mode received from the additional modulation section(s). The additional mode converting reflector is configured to receive the third mode from the additional modulation section(s) and to propagate the fourth mode back through the additional modulation section(s).

In some embodiments, the optical modulator of the optical device includes a splitter that splits an input optical signal into the first mode in the first waveguide arm and the third mode in the third waveguide arm, as well as a combiner that combines the second mode of the second waveguide arm with the fourth mode of the fourth waveguide arm. In some embodiments, the optical modulator may include an electrode signal delay matching section coupled with the electrodes to reduce a velocity mismatch between an electrode signal and an optical signal including the first mode and the second mode. In some embodiments, the optical modulator of the optical device includes an electrode signal filtering network coupled with the electrodes. In some embodiments, the optical modulator is a cascaded modulator including a plurality of stages. A stage may include a mode multiplexer, a modulation section, and a mode converting reflector.

A method is also described. The method includes providing an optical modulator. Providing the optical modulator includes providing at least one electrode and providing a waveguide. Providing the waveguide further includes providing a mode multiplexer, a modulation section, and a mode converting reflector. The modulation section is positioned between and proximate to a portion of the electrode(s) and located in an optical path between the mode multiplexer and the mode converting reflector. The mode multiplexer is configured to propagate a first mode from a first waveguide arm to the modulation section, to receive a second mode from the modulation section, and to provide the first mode to a second waveguide arm based on the second mode received from the modulation section. The mode converting reflector is configured to receive the first mode from the modulation section and to propagate the second mode back through the modulation section. In some embodiments, providing the waveguide further includes providing an additional mode multiplexer, an additional modulation section, and an additional mode converting reflector arranged in a corresponding additional optical path.

Various features of the photonics devices are described herein. One or more of these features may be combined in manners not explicitly described herein. For example, another number of stages may be used, different configurations of the mode multiplexer and/or mode converting reflector, coupling region between TFLC waveguides and other waveguides (e.g., on the same or another optical device) that are aligned with the modulation region may be combined with electrodes that are vertically aligned/offset in at least the modulation region. Similarly, the electrodes used with the TFLC waveguides may and/or may not include some combination of the extensions or electrodes having extended portions described herein. Further, the electrodes and/or waveguides may be configured based on the cut (e.g., x-cut, y-cut, or z-cut) of the electro-optic materials used. Although described in the context of lithium-containing electro-optic materials (e.g., lithium niobate and/or lithium tantalate), in some embodiments, other materials exhibiting the Pockels effect may be used in addition to or in lieu of lithium-containing electro-optic materials. Thus, modulator designs described herein may not be limited to TFLC materials. In addition, the drawings may not be to scale.

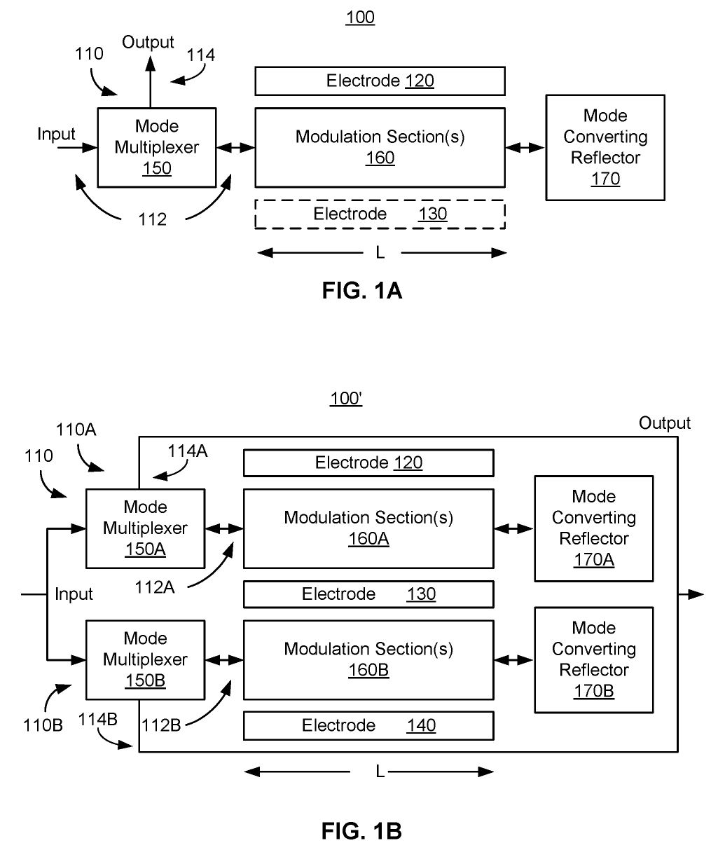

FIGS. 1A and 1B are block diagrams of embodiments of TFLC optical device 100 and 100’ that may be compact. More specifically TFLC optical devices 100 and 100’ are optical modulators that may be part of an electro-optic device and may be a TFLC PIC. Such a TFLC PIC may include a large number of optical modulators 100 and/or 100’. Optical devices 100 and 100’ are thus described as PICs and/or optical modulators. In some embodiments, optical modulators 100 and 100’ are traveling wave modulators. Although described primarily with respect to TFLC modulators 100 and 100’, the design principles may be applied to other integrated photonic platforms, such as silicon, gallium arsenide, and indium phosphide.

Referring to FIG. 1A, optical modulator 100 may be considered a variation of a Michelson modulator. Optical modulator 100 may also be considered a phase modulator. Optical modulator 100 includes electrode 120 and waveguide 110. Waveguide 110 may be a TFLC waveguide. In some embodiments, electrode 130 may be present. This is indicated by the dashed line for electrode 130. Electrode 120 and 130 may be in a single ended or differential configuration in various embodiments. For example, electrode 120 may carry a signal, while electrode 130 is ground (or vice versa), electrode 120 may carry a signal while electrode 130 carries the complement. For example, electrode 120 may carry a signal S, while electrode 130 carries S*, where S* is the opposite of S with respect to a particular voltage (e.g. ground/zero volts, or a bias voltage).

Waveguide 110 includes mode multiplexer 150, modulation section(s) 160, and mode converting reflector 170. Modulation section 160 is proximate to electrodes 120 and 130. In modulation section(s) 160, waveguide 110 is sufficiently close to electrode(s) 120 and/or 130 that the electrode signal may modulate the optical signal carried by waveguide 110. Modulation section 160 is in an optical path between mode multiplexer 150 and mode converting reflector 170. For example, an optical signal input to mode multiplexer 150 may be carried to modulation section(s) 160, and then propagated to mode converting reflector 170. The optical signal may propagate from mode converting reflector 170 back through modulation section(s) 160 to mode multiplexer 150. However, mode multiplexer 150 and mode converting reflector 170 operate based on the optical mode(s) carried in the optical signal.

Mode multiplexer 150 is configured to receive an input optical signal from waveguide arm 112. A first mode (i.e., a first optical mode) of the optical signal carried by waveguide arm 112 is propagated by mode multiplexer 150 along waveguide arm 112 to modulation section 160. The first mode is modulated by the electrode signal carried by electrode(s) 120 and/or 130. Mode multiplexer 150 receives the (modulated) optical signal including a second mode (i.e., a second optical mode) from modulation section 160. Mode multiplexer 150 provides the first mode to second waveguide arm 114 from the second mode received from modulation section 160.

Mode converting reflector 170 performs a reflection of the optical signal propagates the optical signal based on the mode. In particular, mode reflector 170 receives the first mode from modulation section(s) 160 and propagates the second mode back through modulation section 160. The first and second modes may be traveling wave modes.

Thus, in operation, mode multiplexer 150 receives an optical signal input to modulator 100. A first mode is propagated by mode multiplexer 150 to waveguide arm 112. In some embodiments, this mode is the transverse electric fundamental mode (TE0). Other modes may be used in other embodiments. The optical signal/first mode travels along waveguide arm 112 to modulation section 160. The electrode (e.g. microwave) signal in electrode(s) 120 and/or 130 modulates the optical signal/first mode in waveguide arm 112 traveling toward mode converting reflector 170. The optical signal/first mode is then propagated along waveguide arm 112 to mode converting reflector 170. Mode converting reflector 170 changes the propagation direction of the optical signal (e.g., reverses the direction of propagation) and converts the optical signal to include a second mode, such as a higher-order transverse electric mode (e.g., TE1 mode). Thus, mode converting reflector 170 propagates the optical signal/second mode back to modulation section(s) 160. More specifically, a second (e.g., TE1) mode may be provided back along waveguide arm 112 to modulation section(s) 160.

The electrode signal in electrode(s) 120 and/or 130 reflects back (e.g., from the end of electrodes 120 and/or 130). This reflected electrode signal modulates the optical signal (the second mode) from mode converting reflector 170 and carried by modulation section(s) 160. Thus, the optical signal passes through modulation section(s) 160 twice. The effective length of modulation section(s) 160 having physical length L is 2L. The optical signal including the second mode is then propagated from modulation section(s) 160 to mode multiplexer 150 via waveguide arm 112. Mode multiplexer 150 routes the first mode (e.g. the TE0 mode) to second waveguide arm 114. In some embodiments, the optical signal exiting modulator 100 via waveguide arm 114 may be phase modulated.

By changing optical modes within modulation region 160 using mode multiplexer 150 and mode converting reflector 170, and routing the optical signal based on the modes, the optical return loss (e.g. the optical signal traveling out of the optical input) may be significantly reduced. Because the optical signal traverses modulation section 160 twice, stronger modulation can be achieved with a shorter physical device length. Thus, the size of optical modulator 100 may be significantly reduced.

Referring to FIG. 1B, optical modulator 100’ may be considered a variation of a Michelson modulator and a Mach-Zehnder modulator. Thus, optical modulator 100’ may be a hybrid modulator. Optical modulator 100’ may also be considered an amplitude modulator. Optical modulator 100 includes electrodes 120, 130, and 140 and waveguide 110. Waveguide 110 includes waveguides 110A and 110B. Electrodes 120 and 130 and waveguide 110A are analogous to those depicted in modulator 100 of FIG. 1A. Thus, waveguide 110A includes mode multiplexer 150A, modulation section(s) 160A, and mode converting reflector 170A that are analogous to mode multiplexer 150, modulation section(s) 160, and mode converting reflector 170. Waveguide 110B is analogous to waveguide 110 of FIG. 1A. Thus, waveguide 110B includes mode multiplexer 150B, modulation section(s) 160B, and mode converting reflector 170B that are analogous to mode multiplexer 150, modulation section(s) 160, and mode converting reflector 170. Waveguides 110A and 110B may be TFLC waveguides. Electrodes 120, 130, and 140 may be in a single ended or differential configuration in various embodiments. For example, electrode 130 may carry a signal, while electrodes 120 and 140 are ground or electrode 130 may carry a signal while electrodes 120 and 140 carries the complement. For example, electrode 120 may carry a signal S, while electrodes 130 and 140 each carries S*.

Waveguide 110A and electrodes 120 and 130 function in an analogous manner to waveguide 110 and electrodes 120 (and 130) of FIG. 1A. The optical signal entering the optical input is split and a portion directed to mode multiplexer 150A, which propagates the first mode (e.g. TE0) along waveguide arm 112A to modulation region 160A proximate to electrodes 120 and 130. The electrode signal(s) in electrode(s) 120 and/or 130 also travel along modulation region 160A. The electrode signal(s) modulate this mode as it propagates toward mode converting reflector 170A. Mode converting reflector 170A changes (e.g., reverses) the propagation direction and selects a second mode (e.g. TE1) of the optical signal for propagation back through modulation section(s) 160A. The electrode signal(s) also reflect and travel back through modulation section(s) 160A. In modulation section(s) 160A, the optical signal is further modulated by the reflected electrode signal. Upon returning to mode multiplexer 150A, the second mode is converted back into the first mode and routed to waveguide arm 114A, producing a phase-modulated signal.

Similarly, waveguide 110B and electrodes 130 and 140 function in an analogous manner to waveguide 110 and electrodes 120 (and 130) of FIG. 1A. The optical signal entering the optical input is split and a portion directed to mode multiplexer 150B, which propagates the first mode (e.g. TE0) along waveguide arm 112B to modulation region 160B proximate to electrodes 130 and 140. The electrode signal(s) in electrode(s) 130 and/or 140 modulate this mode as it propagates toward mode converting reflector 170B. Mode converting reflector 170B changes the propagation direction and propagates a second mode (e.g. TE1) of the optical signal back through modulation section 160B. The electrode signal(s) in electrodes 130 and/or 140 are also reflected and travel back along electrode(s) 130 and/or 140 toward mode multiplexer 150B. The optical signal is further modulated in modulation section(s) 160B. Upon returning to mode multiplexer 150B, the second mode is converted back into the first mode and routed to waveguide arm 114B, producing a phase-modulated signal. The optical signals (e.g. the modulated first modes) in waveguide arms 114A and 114B are then recombined. The resulting output signal may be an amplitude modulated signal.

Thus, waveguides 110A and 110B provide modulation twice in each modulation section 160A and 160B. The effective length of modulation sections 160A and 160B may thus be twice the physical length L (i.e. an effective length of 2L). The use of mode multiplexers 150A and 150B and may reduce the optical return loss. Thus, optical modulator 100’ may provide the desired optical modulation with a significantly reduced length. More specifically, optical modulator 100’ may have a lower V-pi and a lower V-pi-L. In embodiments in which the modulation is the same for both passes through modulation regions 160A and 160B, the V-pi-L may be reduced by half and the modulator made shorter. Although described in the contexts of TE0 and TE1 modes, other modes may be used. However, if the modulation provided in modulation sections 160A and 160B is mode dependent, this may be considered in the design of optical modulator 100’. For example, TFLN and/or TFLT may provide stronger modulation for TE modes. Thus, TE modes may be preferred over TM modes in some embodiments.

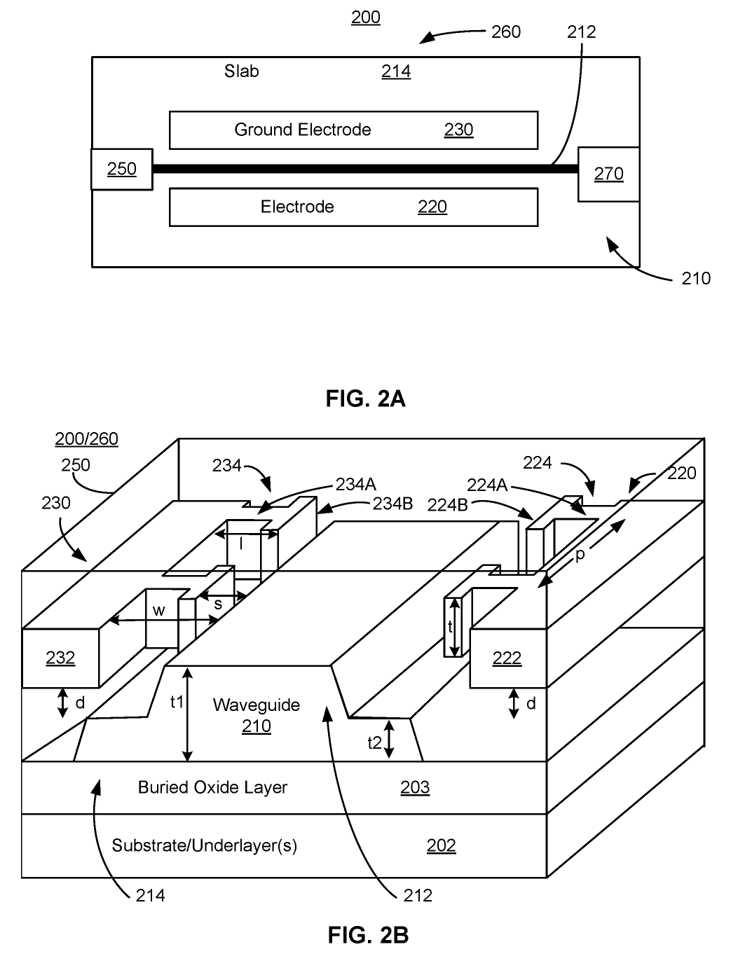

Waveguides 110, 110A and 110B may be TFLC waveguides. Thus, waveguides 110, 110A, and 110B and electrodes 120, 130, and/or 140 may be configured for TFLC devices. For example, FIGS. 2A-2B depict an embodiment of a portion of TFLC PIC 200 that may be used as part or all of modulator(s) 100 and/or 100’. For example, TFLC PIC 100 may be used as modulator 100 of FIG. 1A and waveguides 110A and 110B and electrodes 120, 130, and 140 of FIG. 1B. FIG. 2B is a perspective view of a portion of photonics device 200. FIGS. 2A-2B are not to scale. Only a portion of photonics device 200 is shown. Photonics device 200 may include other and/or additional structures that are not shown for simplicity. Further, although particular configurations are shown, other configurations are possible.

Photonics device 200 is on a substrate structure that includes substrate 202 and buried oxide (BOX) layer 203. In some embodiments, substrate 202 is a silicon substrate. Substrate 202 may also include other layers. In some embodiments, substrate 202 may be glass, quartz, silicon-on-insulator, and/or other low microwave loss dielectrics. Substrate 202 may be one hundred micrometers or more thick. BOX layer 203 may be a silicon dioxide layer. In some embodiments, BOX layer 203 may be at least three micrometers thick and not more than fifteen micrometers thick. In some embodiments, the substrate structure may be configured differently. Also shown is cladding 250, which may be formed of silicon dioxide. Substrate 202 (and/or other portions of photonics device 200) may be removed before final integration or other use of photonics device 200.

Photonics device 200 includes waveguide 210 and electrodes 220, 230, and 240. In some embodiments, photonics device 200 may be configured as or include a modulator (or portion thereof). Thus, photonics device 200 may be considered to include modulation region 249. Other regions, such as a bend region, may be present. Modulator 200 is shown as configured as a Mach-Zehnder modulator. Other configurations for phase and/or amplitude modulation are possible. For clarity, only the portion of electrodes 220, 230, and 240 proximate to waveguide 210 are shown. Stated differently, electrodes 220, 230, and 240 are shown in modulation region 260.

Waveguide 210 may be considered to include ridge 212 as well as slab 214. Ridge 212 has a height, t1, greater than the height, t2, of slab 214. Although shown as rectangles, ridge 212 and/or slab 214 have other shapes, such as trapezoids and/or other analogous shapes. In addition, slab 214 may terminate closer to ridge 212 than at least a portion of electrode(s) 220 and/or 230. Photonics device 200 includes electro-optic optic material(s), such as TFLC materials (e.g. TFLN and/or TFLT). More specifically, ridge 212 and slab 214 include electro-optic materials, such as TFLC materials. In some embodiments, the waveguide 210 consists of TFLC materials such as TFLN and/or TFLT. In the embodiment shown, ridge 212 and slab 214 are formed of the same material. In some embodiments, ridge 212 and slab 214 may include different materials. Waveguide 210, and more particularly ridge 212, may be used to propagate the optical signal. The optical mode may be well confined to ridge 212 and/or ridge 212 in combination with a portion of nearby slab 214. Slab 214 provides increased electro-optic modulation efficiency. In particular, slab 214 aids in directing the electric field generated by the signal(s) in electrodes 220, 230, and 240 to optical mode 213 in modulation region 260. Thus, a higher modulation for a given electric field may be obtained. As a result, V-pi (and V-pi-L) may be reduced.

In some embodiments, the TFLC layer from which TFLC waveguide 210 is formed has a thickness of less than two micrometers or less than one micrometer. Thus, TFLC waveguide 210 may have a thickness of less than two micrometers, less than one micrometer, less than six hundred nanometers, less than five hundred nanometers, or less than four hundred nanometers. The thickness of TFLC waveguide 210 may be at least fifty nanometers. In some embodiments, the TFLC layer has a thickness of at least two hundred and fifty nanometers. For example, TFLC waveguide 210 may be nominally three hundred nanometers or three hundred and fifty nanometers thick with, for example, a 10-15 nanometer variation. The thickness of TFLC waveguide 210 (e.g. t1, to the top of ridge 112) may be not more than three hundred nanometers, not more than three hundred and fifty nanometers, not more than four hundred nanometers, not more than five hundred nanometers, not more than six hundred nanometers, not more than seven hundred nanometers, not more than one micrometer, not more than 1.5 micrometer, and/or not more than two micrometers. In some embodiments, the thickness of TFLC waveguide 210 may be at least more than three hundred nanometers, at least three hundred and fifty nanometers, at least four hundred nanometers, at least five hundred nanometers, at least six hundred nanometers, at least seven hundred nanometers, at least one micrometer, or at least 1.5 micrometer.

The etches also form the sidewall angles for TFLC waveguide 110. The sidewall angles for ridge 112 and/or slab 114 may not exceed ninety degrees and are typically less than ninety degrees (e.g., not quite vertical). For example, the sidewall angles may be less than 85 degrees, less than 80 degrees, less than 75 degrees, and/or less than 70 degrees The sidewall angles may be desired to be steep. For example, the sidewall angles may be at least forty-five degrees, at least fifty-five degrees, or at least sixty degrees. The sidewalls may also have a lower surface roughness (e.g., less than ten nanometers), allowing for low optical losses in waveguides 210. TFLC waveguide 210 has a width (e.g., a smallest feature size) corresponding to the width of ridge 212. In some embodiments, the width of TFLC waveguide (i.e., TFLC optical structure) 210/ridge 212 is not more than one micrometer. This may be the smallest feature size for the TFLC waveguide 110. In some embodiments, the smallest feature size in the TFLC waveguide 110 is not more five hundred nanometers. In some such embodiments, the smallest feature size of TFLC waveguide 110 is not more than two micrometers or not more than one micrometer.

Electrodes 220, 230, and 240 may carry electrode signals used to modulate the optical signals (e.g. light) carried by waveguide 210 via electro-optic modulation. Electrode(s) 220 and/or 230 are configured to carry a traveling wave (e.g. a microwave or RF electrode signal) that modulates the optical signal carried by waveguide 210 via the electro-optic effect. For example, the electrode signals may provide electro-optic modulation up to frequencies of 100 GHz, 200 GHz, 500 GHZ or higher. In some embodiments, modulator 210 may provide modulation from at or near DC to frequencies of 100 GHz, 200 GHz, 500 GHz, or more. The modulation may also have a wide window, for example an operation bandwidth of at least 20 GHz. Electrode signals carried by electrodes 220, 230, and 240 may be configured in a variety of manners. For example, electrode 230 may carry a microwave signal, while electrodes 220 and 240 are ground. Electrode 230 may carry a signal of a first polarity, while electrodes 220 and 240 carry signals of opposite polarity (i.e. in a differential configuration). Other configurations (including but not limited to another number of electrodes) are possible.

Electrodes 220, 230, and/or 240 may include extensions. Embodiments of analogous electrodes may be found in co-pending U.S. Patent Application Serial No. 17/843,906, entitled ELECTRO-OPTIC DEVICES HAVING ENGINEERED ELECTRODES, which is a continuation of U.S. Patent Application No. 17/102,047 entitled ELECTRO-OPTIC DEVICES HAVING ENGINEERED ELECTRODES, filed Nov. 23, 2020, which claims priority to U.S. Provisional Patent Application No. 62/941,139 entitled THIN-FILM ELECTRO-OPTIC MODULATORS filed Nov. 27, 2019, U.S. Provisional Patent Application No. 63/033,666 entitled HIGH PERFORMANCE OPTICAL MODULATORS filed Jun. 2, 2020, and U.S. Provisional Patent Application No. 63/112,867 entitled BREAKING VOLTAGE-BANDWIDTH LIMIT IN INTEGRATED LITHIUM NIOBATE MODULATORS USING MICRO-STRUCTURED ELECTRODES filed Nov. 12, 2020, all of which are incorporated herein by reference for all purposes. In other embodiments, extensions may be omitted from some or all of electrodes 220, 230, and/or 240. Electrodes 220, 230, and 240 may carry differential electrical signals, a single electrical signal (e.g. a signal and ground), or other signal(s).

Electrode 230 includes a channel region 232 and extensions 234 (of which only one is labeled in FIG. 2B). Similarly, electrode 220 includes channel region 222 and extensions 224 (of which only one is labeled in FIG. 2B). In some embodiments, extensions 224 or 234 may be omitted from electrode 220 or electrode 230, respectively. Extensions 224 and 234 may be closer to ridge 212 than channel region 222 and 232, respectively, are. For example, the distance s from extensions 224 and 234 to waveguide ridge 212 is less than the distance w from channels 222 and 232 to waveguide ridge 212. Extensions 224 may be closer to electrode 230 (e.g. extensions 234 and/or channel 232) than channel 222 is. Similarly, extensions 234 may be closer to electrode 220 e.g. extensions 224 and/or channel 222) than channel 232 is.

Extensions 224 and 234 are in proximity to ridge 212. For example, extensions 224 and 234 are a vertical distance, d from slab 214 of TFLC waveguide 210. The vertical distance to TFLC waveguide 210 may depend upon the cladding 250 used. The distance d is highly customizable in some cases. For example, d may range from zero (or less if electrodes 220 and 230 contact or are embedded in slab portion 214) to greater than the height of ridge 212. In embodiments in which slab 214 terminates closer to ridge 212 than channel regions 222 and 232, d may be zero (same level as the top surface of slab 214), positive (further from substrate 202 than the top surface of slab 214), or negative (further from substrate 202 than the top surface of slab 214). However, d is generally still desired to be sufficiently small that electrodes 220 and 230 can apply the desired electric field to ridge 212. Extensions 224 and 234 are also a distance, s, from ridge 212. In some embodiments, s <0 (i.e., extensions 224 and/or 234 may extend over the top of ridge 212 or below waveguide 210). Extensions 224 and 234 are desired to be sufficiently close to TFLC waveguide 210 (e.g. close to ridge 212) that the desired electric field and index of refraction change can be achieved. However, extensions 224 and 234 are desired to be sufficiently far from TFLC waveguide 210 (e.g. from ridge 212) that their presence does not result in undue optical losses. Although shown next to ridge 212, extensions 224 and/or 234 may extend above and/or below ridge 212.

In the embodiment shown, extensions 224 have a connecting portion 224A and a retrograde portion 224B. Retrograde portion 224B is so named because a part of retrograde portion may be antiparallel to the direction of signal transmission through electrode 220. Similarly, extensions 234 have a connecting portion 234A and a retrograde portion 234B. Thus, extensions 224 and 234 have a “T”-shape. In some embodiments, other shapes are possible. For example, extensions 224 and/or 234 may have an “L”-shape, may omit the retrograde portion, may be rectangular, trapezoidal, parallelogram-shaped, may partially or fully wrap around a portion of ridge 212, and/or have another shape. Similarly, channel regions 222 and/or 232, which are shown as having a rectangular cross-section, may have another shape. Further, extensions 224 and/or 234 may be different sizes. Although all extensions 224 and 234 are shown as the same distance from ridge 212, some of extensions 224 and/or some of extensions 234 may be different distances from ridge 212. Channel regions 222 and/or 232 may also have a varying size.

Also indicated in FIG. 2B is thickness, t, of extensions 224 and 234. In the embodiment shown, channels 222 and 232 have the same thickness. In some embodiments, the thickness of extensions 224 and/or 234 may vary. For example, extensions 224 may be thinner (or thicker) than extensions 234. Further, different extensions 224 may have different thicknesses. Similarly, different extensions 234 may have different thicknesses. Extensions 224 and/or 234 may also have a different thickness than channels 222 and/or 232. For example, extensions 224 and/or 234 may be thinner (or thicker) than channels 222 and/or 232. Different portions of extensions 224 and/or 234 may also have different thicknesses. For example, retrograde portions 224B and/or 234B may be thinner (or thicker) than connecting portions 224A and/or 234A. Thus, TFLC PICs 200 and 100 may have a variety of configurations, components, and functions. Performance of TFLC PICs 200 and 100 may be superior to that of other, non-TFLC PICs.

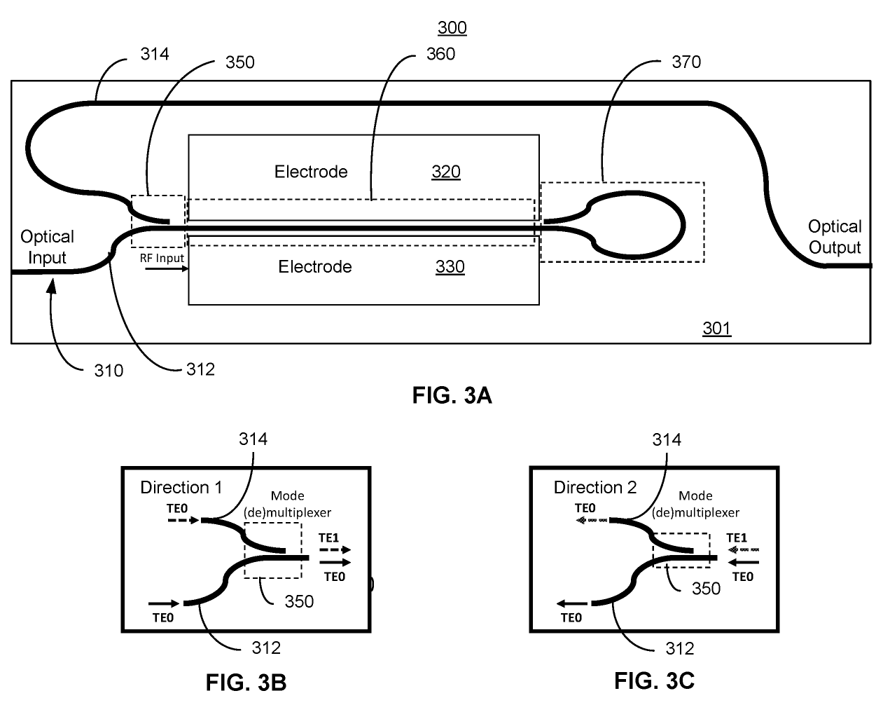

FIGS. 3A-3C are diagrams depicting an embodiment of TFLC optical modulator 300. Optical modulator 300 is shown as part of optical device 301. Optical device 301 may be a TFLC optical device (e.g., a PIC) that may include other components. FIG. 3A depicts a plan view of optical modulator 300. FIGS. 3B and 3C depict portions of optical modulator during operation with optical signals traveling in different directions. In some embodiments, modulator 300 is a traveling wave modulator.

Referring to FIG. 3A, optical modulator 300 may be considered a variation of a Michelson modulator and a phase modulator. Thus, optical modulator 300 may be considered analogous to optical modulator 100. Optical modulator 300 includes electrodes 320 and 330 and waveguide 310 that are analogous to electrodes 120 and 130 and waveguide 110. Further, electrodes 320 and/or 330 may be analogous to electrodes 220 and/or 230. For example, electrodes 320 and/or 330 may include extensions (not shown). Electrodes 320 and 330 may be in a single ended or differential configuration in various embodiments.

Waveguide 310 (and thus waveguide arms 312 and 314) may be considered a high confinement region for the optical signal. Thus, waveguide 310 may be analogous to ridge 212. Although optical modulator 300/waveguide 310 may include a slab portion of TFLC material, this portion is not explicitly indicated. Thus, waveguide 310 includes mode multiplexer 350, modulation section(s) 360, and mode converting reflector 370 that are analogous to mode multiplexer 150, modulation section(s) 160, and mode converting reflector 170.

Mode multiplexer 350 is shown as an adiabatic mode multiplexer. Mode converting reflector 370 may be considered a modified Sagnac loop. For example, mode converting reflector 370 may be considered to include an adiabatic mode multiplexer analogous to mode multiplexer 350 as part of the Sagnac loop. In some embodiments, mode multiplexer 350 and/or mode converting reflector 370 may be configured in a different manner.

For example, FIGS. 3B and 3C depict the propagation of modes through mode multiplexer 350. Propagation through an analogous portion of mode converting reflector 370 functions in a similar manner. Arms 312 and 314 (arm 312 if used in mode converting reflector 370) are shown as having a constant width. However, waveguide arms 312 and 314 are tapered in order to provide the adiabatic transition. For example, upper waveguide arm 314 (or 312 for mode converting reflector 370) may be tapered to a smaller width proximate to mode multiplexer 350. Lower waveguide arm 312 (also 312 for mode converting reflector 370) may be tapered to a larger width proximate to mode multiplexer 350. As can be seen in FIG. 3B, for a TE0 mode input from the lower waveguide arm 312 (indicated by a solid arrow), a TE0 mode is propagated by mode multiplexer 350. This mode will continue on waveguide arm 312 to modulation section(s) 360 (indicated by a solid arrow). Similarly, if a TE1 mode (indicated by a dashed arrow) received from upper waveguide arm 314, the TE1 mode is propagated by mode multiplexer 350 on waveguide arm 312 as a TE1 mode (indicated by a dashed arrow). FIG. 3C indicates the situation in which the modes are received into mode multiplexer 350 on waveguide arm 312 from modulation region(s) 360. A TE1 mode received on waveguide arm 312 (indicated by a dashed arrow) is propagated, or transferred, to waveguide arm 314 and output as a TE0 mode. A TE0 mode (indicated by a solid arrow) received on waveguide arm 312 is propagated out of waveguide arm 312 as a TE) mode (indicated by a solid arrow).

Waveguide 310 and electrodes 320 and 330 function in an analogous manner to waveguide 110 and electrodes 120 (and 130) of FIG. 1A. The optical signal entering the optical input is provided by waveguide 310 on arm 312 to mode multiplexer 350. Adiabatic mode multiplexer 350 propagates the first mode (e.g. TE0) along waveguide arm 312 to modulation section(s) 360 proximate to electrodes 320 and 330. This operation is indicated by the solid arrows (TE0 mode) in FIG. 3B. The electrode signal(s) in electrode(s) 320 and 330 modulate this mode as it propagates toward mode converting reflector 370. Mode converting reflector 370 changes (e.g., reverses) the propagation direction and propagates a second mode (e.g. TE1) of the optical signal back through modulation section 360. The electrode signal(s) in electrode(s) 320 and/or 330 also reflect back and travel along modulation section(s) 360. The optical signal is further modulated. Upon returning to mode multiplexer 350, the second mode is converted back into the first mode and routed to waveguide arm 314A, producing a phase-modulated signal. This function is indicated in FIG. 3C by the dashed arrows (TE1 mode). In some embodiments, waveguide 310 is an x-cut TFLC (e.g., TFLN) waveguide. In such embodiments, TE modes may be used and the waveguide 310 geometry in the modulator may be configured (e.g. with a sufficiently wide ridge 212) such that both selected modes have strong confinement in the TFLC (at least better than 0.5 energy confinement, better than 0.7, better than 0.8, and/or better than 0.9 in some embodiments) so as to experience large electro-optic (EO) effect in modulation section(s) 360. In some embodiments, configuring waveguide 310 for the desired confinement includes selecting the height and width of the ridge for waveguide arms 312 and 314. In other embodiments, other modes (e.g. TM modes or different TE modes) and/or other configurations might be used.

In some embodiments, the different speeds at which TE0 and TE1 modes travel may be accounted for to maintain velocity matching (e.g., within twenty percent, within ten percent, within five percent, or within two percent) between the RF electrode signal(s) carried by electrode(s) 320 and/or 330 and the optical signal carried by waveguide 310 in modulator 300. In some embodiments, maintaining the desired (small) velocity mismatch may include one or more of ensuring that optical modulator 300 is sufficiently short; configuring waveguide 310 (including modulation section(s) 360 and mode converting reflector 370) such that the velocity mismatch increases as the optical signal traverses modulation section 360 in one direction and decreases as the optical signal traverses modulation section(s) 360 in the opposite direction; providing an electrode signal delay in electrodes 320 and/or 330; providing an optical path difference distal from electrodes 320 and 330 to maintain the desired phase; and/or other techniques.

Optical modulator 300 and optical device 301 may share the benefits of optical modulator 100. Because the optical signal passes through modulation section(s) 360 twice, the effective length of modulation section(s) 360 having physical length L may be approximately 2L. This may provide desired modulation in a shorter length and more compact footprint. Thus, optical modulator 300 may have a lower V-pi and a lower V-pi-L. For example, depending upon the V-pi desired, the length of optical modulator 300 may be at least one mm and not more than 3 cm in total length. As used herein, modulator length may be the length of the modulation region or the total length of the modulator from input to the output. In addition, although the output of modulator 300 is shown on the opposite side from the input, in some embodiments, the output may be located elsewhere. For example, the output may be located along the same side or edge as the input. In such embodiments, waveguide arm 314 may not extend only to the same edge as the input.

Through the use of mode multiplexer 350 and mode converting reflector 370, the optical signal may be routed based on the modes. Thus, the optical return loss may be significantly reduced. Further, the benefits of TFLC, such as lower losses, higher frequency operation, and a larger bandwidth may be achieved.

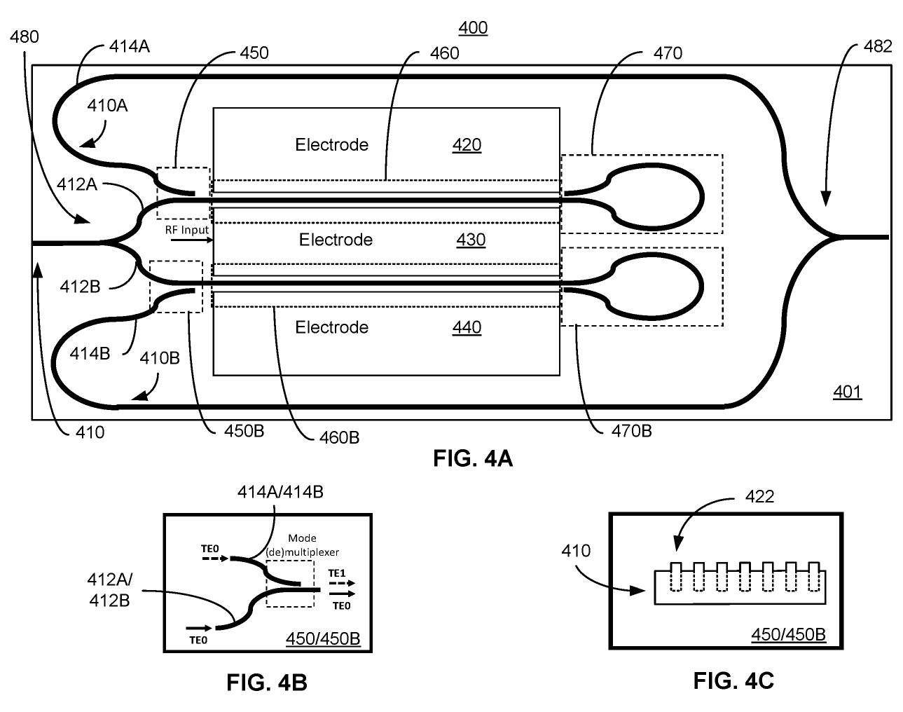

FIGS. 4A-4C are diagrams depicting an embodiment of TFLC optical modulator 400. Optical modulator 400 is shown as part of optical device 401. Optical device 401 may be a TFLC optical device (e.g., a PIC) that may include other components. FIG. 4A depicts a plan view of optical modulator 400. FIGS. 4B and 4C depict portions of embodiments of optical modulator 400 during operation with optical signals traveling in different directions. In some embodiments, modulator 400 is a traveling wave modulator.

Referring to FIG. 4A, optical modulator 400 may be considered a variation of a Michelson modulator and a Mach-Zehnder modulator. Optical modulator 400 may be a hybrid modulator. Optical modulator 400 may also be considered an amplitude modulator. Thus, optical modulator 400 may be considered analogous to optical modulator 100’. Optical modulator 400 includes electrodes 420, 430, and 440 and waveguide 410 that are analogous to electrodes 120, 130, and 140 and waveguide 110. Waveguide 410 includes waveguides 410A and 410B. Electrodes 420 and 430 and waveguide 410A are analogous to those depicted in modulator 400 of FIG. 4A as well as electrodes 120 and 130 and waveguides 110/110A of modulators 100/100’ of FIGS. 1A-1B. Thus, waveguide 410A includes mode multiplexer 450A, modulation section(s) 460A, and mode converting reflector 470A that are analogous to mode multiplexer(s) 450 and/or 150/150A, modulation section(s) 460 and/or 160/160A, and mode converting reflector(s) 470 and/or 170/170A. Waveguide 410B is analogous to waveguide 410 of FIG. 4A and waveguide 110B of FIG. 1B. Thus, waveguide 410B includes mode multiplexer 450B, modulation section(s) 460B, and mode converting reflector 470B that are analogous to mode multiplexers 450 and 150B, modulation section(s) 460 and 160B, and mode converting reflector 470 and 170B. Waveguides 410A and 410B may be TFLC waveguides. Electrodes 420, 430, and 440 may be in a single ended or differential configuration in various embodiments.

Waveguide 410A and electrodes 420 and 430 function in an analogous manner to waveguide 310 and electrodes 320 and 330 of FIG. 3A as well as waveguide 110A and electrodes 120 and 130 of FIG. 1B. The optical signal entering the optical input is split at splitter 480 and a portion directed along waveguide arm 412A to mode multiplexer 450A. Mode multiplexer 450A propagates the first mode (e.g. TE0) along waveguide arm 412A to modulation region 460A proximate to electrodes 420 and 430. The electrode signal(s) in electrode(s) 420 and 430 modulate this mode as it propagates toward mode converting reflector 470A. Mode converting reflector 470A changes (e.g., reverses) the propagation direction and provides a second mode (e.g. TE1) of the optical signal for propagation back along waveguide arm 412A through modulation section(s) 460A. The electrode signal(s) in electrode(s) 420 and/or 430 also reflect back. Thus, the second mode is modulated as it passes through modulation section(s) 460A and returns to mode multiplexer 450A. Mode multiplexer 450A, the second mode may be considered to be converted back into the first mode and routed to waveguide arm 414A.

Similarly, waveguide 410B and electrodes 430 and 440 function in an analogous manner to waveguide 310 and electrodes 320 and 330 of FIG. 3A, waveguide 410A and electrodes 420 and 430 of FIG. 4A, or waveguide 110/110B and electrodes 130 and 140 of FIGS. 1A-1B. The optical signal entering the optical input is split by splitter 480 and a portion directed along waveguide arm 412B to mode multiplexer 450B, which propagates the first mode (e.g. TE0) along waveguide arm 412B to modulation region 460B proximate to electrodes 430 and 440. The electrode signal(s) in electrode(s) 430 and 440 modulate this mode as it propagates toward mode converting reflector 470B. Mode converting reflector 470B changes the propagation direction and propagates a second mode (e.g. TE1) of the optical signal back along waveguide arm 412B through modulation section 460B. The electrode signal(s) traveling in electrode(s) 530 and/or 540 also reflect back. The optical signal is, therefore, further modulated and returns to mode multiplexer 450B. Mode multiplexer essentially converts the second mode back into the first mode and routes this mode to waveguide arm 414B. The optical signals (e.g. the modulated first modes) in waveguide arms 414A and 414B are then recombined at combiner 482. The resulting output signal may be an amplitude modulated signal. Although the output indicated as being on the opposite side from the input, the output may be located elsewhere. In some embodiments, the input may be on the same side as the output. In such embodiments, there may be waveguide crossings and combiner 482 may be located closer to splitter. 480.

FIGS. 4B and 4C depict possible embodiments of mode multiplexer 450A and 450B. FIG. 4B depicts mode multiplexers 450A and 450B provided using adiabatic mode multiplexers. This configuration is analogous to the configurations indicated in FIGS. 3B-3C. FIG. 4C depicts a grating mode multiplexer. The grating 422 may be formed with raised portions above waveguide 410 or by etching into waveguide 410 (indicated by dotted lines in FIG. 4C). However, operation of the mode multiplexers depicted in FIGS. 4A and 4B is analogous to operation of mode multiplexers 150 and 350.

Optical modulator 400 and optical device 401 may share the benefits of optical modulators 100’ and 300. Thus, waveguides 410A and 410B provide modulation twice in each modulation section 460A and 460B. The effective length of modulation sections 460A and 460B may thus be twice the physical length L (i.e. an effective length of 2L). The use of mode multiplexers 450A and 450B may reduce the optical return loss. Thus, optical modulator 400 may provide the desired optical modulation with a significantly reduced length. Optical modulator 400 may have a lower V-pi and a lower V-pi-L. In embodiments in which the modulation is the same for both passes through modulation regions 460A and 460B, the V-pi-L may be reduced by half and the modulator made shorter. Although described in the contexts of TE0 and TE1 modes, other modes may be used. However, if the modulation provided in modulation sections 460A and 460B is mode dependent, this may be considered in the design of optical modulator 400. For example, TFLN and/or TFLT may provide stronger modulation for TE modes. Thus, TE modes may be preferred over TM modes in some embodiments. In addition, optical modulator 300 may be a TFLC modulator. Thus, the configuration for the velocity matching, cut (e.g. x-cut), modes, and other characteristics may be analogous to that described for optical modulator 300. For example, the confinement and/or velocity matching techniques discussed herein with respect to optical modulator 300 may be utilized with optical modulator 400. Through the use of mode multiplexers 450A and 450B and mode converting reflectors 470A and 470B, the optical signal may be routed based on the modes. Thus, the optical return loss may be significantly reduced. Further, the benefits of TFLC, such as lower losses, higher frequency operation, and a larger bandwidth may be achieved.

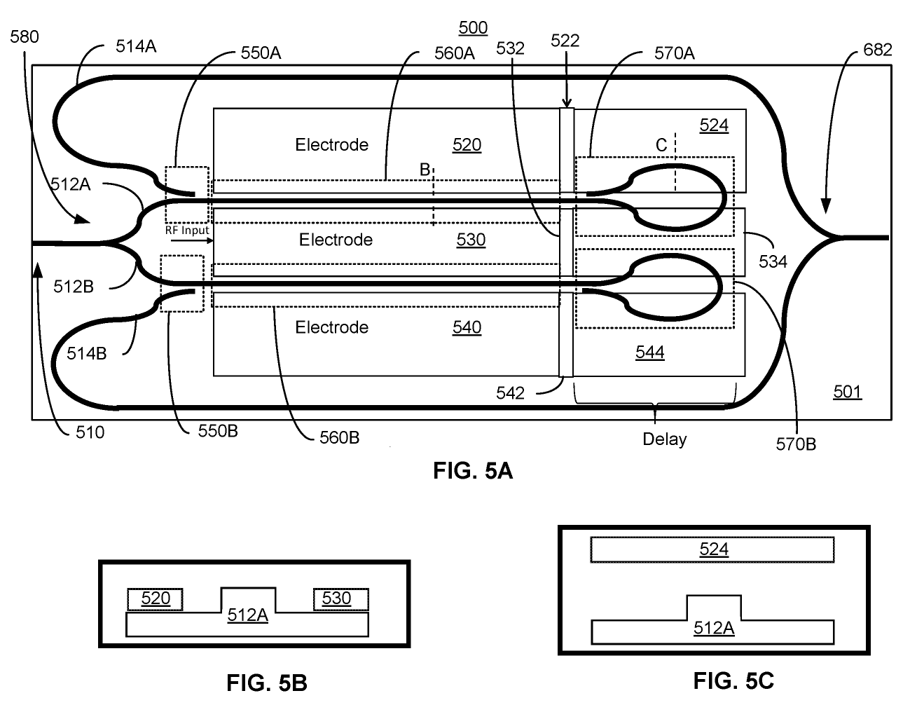

FIGS. 5A-5C are diagrams of embodiments of TFLC optical modulator 500. Optical modulator 500 is shown as part of optical device 501. Optical device 501 may be a TFLC optical device (e.g., a PIC) that may include other components. FIG. 5A depicts a plan view of optical modulator 500. FIGS. 5B and 5C depict cross-sectional views of portions of optical modulator 500 along dotted lines B and C, respectively, shown in FIG. 5A. In some embodiments, optical modulator 500 is a traveling wave modulator. Modulator 500 indicates one way in which electro-optic efficiency may be further improved.

Referring to FIG. 5A, optical modulator 500 is analogous to optical modulator 400. Optical modulator 500 includes electrodes 520, 530, and 540 and waveguide 510 that are analogous to electrodes 420, 430, and 440 and waveguide 410. Waveguide 510 includes waveguides 510A and 510B that are analogous to waveguides 410A and 410B. Electrodes 520 and 530 and waveguide 510A including mode multiplexer 550A, modulation section(s) 560A, mode converting reflector 570A and waveguide arms 512A and 514A are analogous to electrodes 420 and 430 and waveguide 410A including mode multiplexer 450A, modulation section(s) 460A, mode converting reflector 470A and waveguide arms 412A and 414A. Electrodes 530 and 540 and waveguide 510B including mode multiplexer 550B, modulation section(s) 560B, mode converting reflector 570B and waveguide arms 512B and 514B are analogous to electrodes 430 and 440 and waveguide 410B including mode multiplexer 450B, modulation section(s) 460B, mode converting reflector 470AB and waveguide arms 412B and 414B. Thus, waveguides 510A and 510B and electrodes 520, 530, and 540 function in an analogous manner to waveguides 410A and 410B and electrodes 420, 430, and 440. In addition, the configuration for the velocity matching, cut (e.g. x-cut), modes, and other characteristics of optical modulator 500 may be analogous to that described for optical modulator(s) 300 and/or 400.

In addition, optical modulator 500 includes conductive vias 522, 532 and 542 for electrodes 520, 530, and 540, respectively. Conductive vias 522, 532, and 542 electrically connect electrode 520, 530, and 504, respectively, to delay sections 524, 534, and 544, respectively. As can be seen by a comparison between FIGS. 5B and 5C, the electrodes 520, 530, and 540 may be much closer to waveguides 512A and 512B in modulation sections 560A and 560B than delay sections 524, 534, and 544 are to waveguides 512A and 512B. Delay sections 524, 534, and 544 are used to further improve performance of optical modulator 500.

In a high-bandwidth traveling wave modulator (e.g., modulators 100, 100’, 200, 300, 400, and/or 500), it is desirable to control the relative group delay of optical and RF fields during reflection to avoid sharp decreases in EO efficiency. In conventional Michelson modulator designs, the RF transmission line terminates when the electro-optic modulation stops (e.g. at the end of the modulation sections 560A and 560B). However, because the optical reflector typically has some group delay (e.g. in the range of 10-100 micrometers for grating based structures, and 50-1000 micrometers for Sagnac-type reflectors), this leads to a reflection group delay mismatch between RF and optical fields, which can be significant for high bandwidth modulators. This mismatch is analogous to a velocity mismatch between the electrode signal(s) and the optical signals. For a velocity-matched Michelson modulator, the differential group delay between optical and RF fields may be desired to be less than half an RF period of the highest RF frequency to avoid electro-optic response minima. In some embodiments, the differential group delay mismatch is less than a half, a quarter, or a twentieth of a period of the maximum RF frequency of the electrode signal(s) to avoid delay matching losses in the electro-optic rolloff.

In optical modulator 500, however, delay sections 524, 534, and 544 add an RF delay to the end of the modulator (or end of modulation section(s) 560A and 560B) after the modulation region. Delay sections 524, 534, and 544 may improve group delay matching between the optical and RF fields (i.e. the optical signal and the electrode signal) during reflection. Vias 522, 532, and 542 extend the transmission line carrying the electrode signal into delay sections 524, 534, and 544. As can be seen in FIGS. 5B and 5C, delay sections 524, 534, and 544 are part of another metal layer. In some embodiments, this metal layer does not interfere with the optical reflection structures of mode converting reflectors 570A and 570B. In some embodiments, if the mode converting reflectors 570A and 570B are small, the transmission lines including 520, 522, and 524; 530, 532, and 534; and 540, 542, and 544 may be extended with a wider gap to avoid mode converting reflectors 570A and 570B. In some embodiments, the transmission line(s) (e.g. in delay sections 524, 534, and/or 544) may be bent before mode converting reflectors 570A and 570B. Thus, the desired delay to electrode signal(s) may be provided without adversely affecting optical performance. In some embodiments, lumped element devices such as inductors and capacitors may be used to provide a group delay in RF reflection.

Thus, optical modulator 500 and optical device 501 may share the benefits of optical modulators 100’, 300 and/or 400. Thus, because the optical signals traverse modulation section(s) 560A and 560B twice, optical modulator 500 may provide the desired optical modulation with a significantly reduced length. Optical modulator 500 may have a lower V-pi and a lower V-pi-L. Through the use of mode multiplexers 550A and 550B and mode converting reflectors 570A and 570B, the optical signal may be routed based on the modes. Thus, the optical return loss may be significantly reduced. Further, the benefits of TFLC, such as lower losses, higher frequency operation, and a larger bandwidth may be achieved.

In addition, delay sections 524, 534, and 544 may further improve performance. In some embodiments, delay sections may provide the desired differential group delay mismatch. In some embodiments, the differential group delay mismatch is less than a half, a quarter, or a twentieth of a period of the maximum RF frequency of the electrode signal(s) to avoid delay matching losses in the electro-optic rolloff. In some embodiments, it may be beneficial to have a non-zero differential group delay mismatch between RF and optical fields, for example to compensate for differences in optical group index between the different optical modes used in the structure. Thus, delay sections 524, 534, and/or 544 may be configured to provide the desired differential group delay mismatch. For example, in some embodiments, a large delay mismatch in the reflection (e.g., one hundred micrometers or larger) may cause a reduction in the electro-optic rolloff. This may be compensated for using delay sections 524, 534, and/or 544. Moreover, operation of modulator 500 may be desired to remain in the high electro-optic response regime. To remain in the high electro-optic response regime, the length of modulator 500 may be limited. For example, the total length of optical modulator 500 (from input to output) may be not more than 1/20 of the wavelength of the RF electrode signal carried by electrode(s) 520, 530, and/or 540; not more than 1/10 of the wavelength of the RF electrode signal; not more than 1/8, of the wavelength of the RF electrode signal; not more than ¼ of the wavelength of the RF electrode signal; or not more than ½ of the wavelength of the RF electrode signal. In some embodiments, the total length of optical modulator 500 is at least 1/50 of the wavelength of the RF electrode signal. Thus, the high electro-optic modulation range may be extended to 100 GHz or more. In other embodiments, modulator 500 may be long with respect to the wavelength of the RF electrode signal. By incorporating appropriate RF delay sections 524, 534, and/or 544, the differential group delay may be reduced to a fraction of the radio-frequency period. Thus, a high electro-optic response may be maintained at frequencies extending to 100 gigahertz or higher.

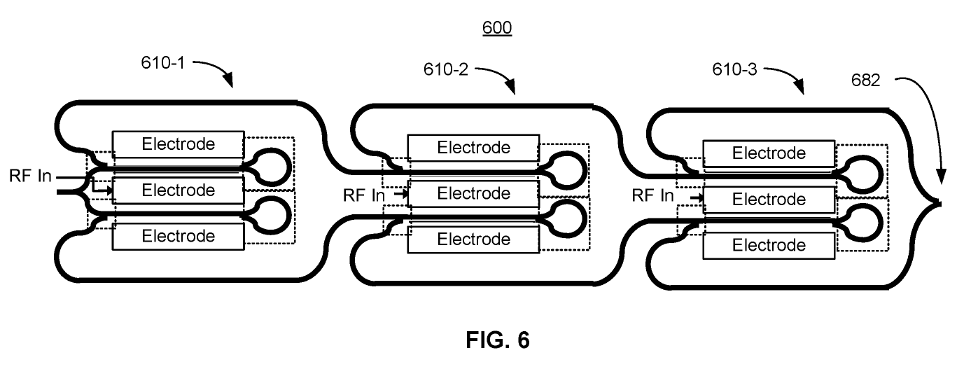

FIG. 6 is a diagram of an embodiment of TFLC optical modulator 600. Optical modulator 600 includes multiple stages 610-1, 610-2, and 610-3 (collectively or generically 610) that are cascaded. Stages 610 are analogous to optical modulator(s) 100’, 400, and/or 500. In other embodiments, each stage may be analogous to optical modulator(s) 100 and/or 300. Although not specifically shown, delay sections analogous to delay sections 524, 534, and 544 may be present. Further, instead of the output of each stage 600 being combined, the outputs of all stages are combined by combiner 682. Although three stages 610 are shown, another number may be present. In some embodiments, a large number of stages may be present. For example, the number of stages 610 may be as low as 2, up to 128, or higher.

Each stage 610 may have the benefits of modulators 100’, 400, and/or 500’. Thus, each stage may provide improved V-pi and/or V-pi L and reduced electro-optical return loss. The benefits of TFLC, such as lower losses, higher frequency operation, and a larger bandwidth may be achieved. In some embodiments, the total length of modulator 600 may be at least one millimeter and not more than three centimeters. However, each stage 610 may have a shorter length. For example, each stage 610 may be not more than one millimeter long. In some embodiments, each stage 610 is at least 100 micrometers and not more than 200 micrometers long, at least 200 micrometers and not more than 500 micrometers long, or at least 500 micrometers and not more than one millimeter long. Thus, the total length of optical modulator 600 may be in the desired range. Because each stage 610 is shorter in length, the velocity mismatch between the electrode signal carried by the electrodes of each stage and the optical signal introduced by each stage may be reduced. Moreover, in optical modulator 600, each stage is separately driven with an input RF signal (through RF in). These input RF signals may be timed to further reduce the velocity mismatch. Thus, in addition to other benefits, the velocity matching may be improved for optical modulator 600.

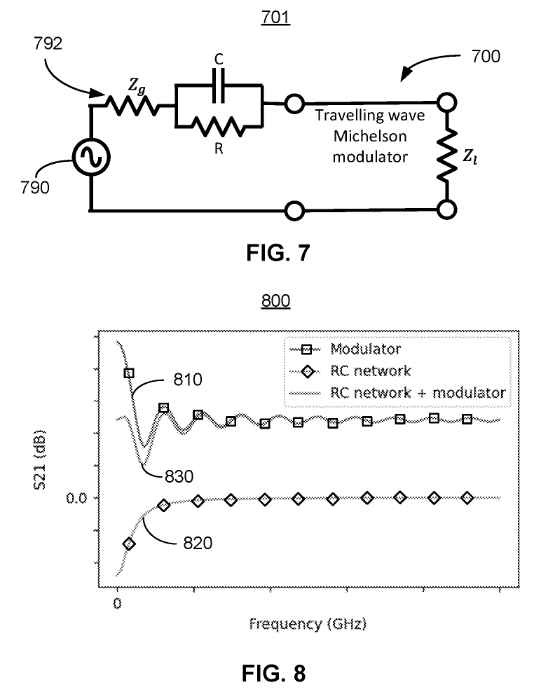

FIG. 7 is a diagram of an embodiment of TFLC optical modulator 700 in optical device 701. Optical device 100 also includes filtering network 792 and driver 790. Driver 790 may be off-chip. Network 792 includes impedances Z_{g} and Zₗ, capacitor C, and resistance R. FIG. 8 is a graph 800 depicting the response of an embodiment of TFLC optical device 700. Graph 810 is for explanatory purposes only and not intended to represent a particular embodiment.

Optical modulator 700 may be analogous to modulators 100, 300, and/or portions of modulators 100’, 400, 500, and/or 600. Thus, optical modulator 700 may be analogous to a Michelson modulator. Plot 810 indicates the response of modulator 700 if driven in the absence of filtering network 792. Plot 810 indicates that there is a low frequency drop off for modulator 700. The drop off in the response 810 is caused by the voltage doubling effect created by an effective open load in the low frequency regime where the length of modulator 700 is short compared to the RF wavelength of the electrode signal. In this regime (modulator length short compared to the RF wavelength), the modulation efficiency may be four multiplied by the response of an equivalent matched Mach-Zehnder modulator. As the length of modulator 700 becomes long compared to the RF wavelength, the counter propagating RF field may be neglected. The modulation efficiency becomes twice that of an equivalent Mach-Zehnder modulator. This is due only to the doubled modulation length because of two passes through the modulation section (e.g. modulation section 160). The transition between these two regimes creates a drop in electro-optic response which may cause time-domain artifacts, which are undesirable in an optical communications application.

This low-frequency drop of modulator 700 may be compensated for through digital signal processing in the optical link (not explicitly shown). Alternatively, driver 790 or other analog electronics may be used to compensate for this drop. However, it may also be possible to compensate for the drop (in whole or in part) using filtering network 792. Filtering network 792 is a passive high-pass filter that may be built into modulator IC 701 or the IC for driver 790. For example, filtering network 792 may have values of R=1 kOhm (e.g. 900 Ohms-2 kOhm in some embodiments), Zₗ = 1 kOhm (e.g. 900 Ohms-2 kOhm in some embodiments), and C = 12fF (e.g., 8 fF-50 fF) may provide a -6dB response at low frequency with a cutoff frequency of roughly 10GHz to compensate for the rolloff of modulator 700. Plot 820 indicates the response of filtering network 792. The compensation is indicated in plot 830. Thus, in some embodiments, on-chip filtering network 792 may provide compensation for the low frequency drop of modulator 700.

Thus, optical modulator 700 and optical device 701 may share the benefits of optical modulators 100, 100’, 300, 400, 500, and/or 600. Optical modulator 700 may provide the desired optical modulation with a significantly reduced length. Optical modulator 700 may have a lower V-pi and a lower V-pi-L. The optical return loss for optical modulator 700 may be significantly reduced. Further, the benefits of TFLC, such as lower losses, higher frequency operation, and a larger bandwidth may be achieved. In addition, the differential delay may be compensated for to improve the electro-optic response. Further, the low frequency drop off of modulator 700 may be compensated for by filtering network 792 or other electronics. Thus, performance may be further improved.

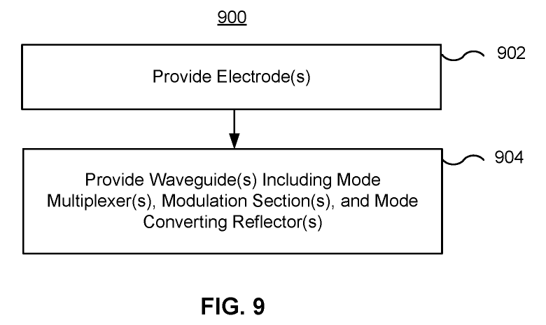

FIG. 9 is a flow chart depicting an embodiment of method 900 for providing a compact TFLC optical device. Method 900 provides an optical modulator. Method 900 is described in the context of processes that may have sub-processes. Although described in a particular order, another order not inconsistent with the description herein may be utilized. Method 900 is also described in the context of TFLC optical modulators 100 and/or 100’. However, method 900 may be used with other devices. In some embodiments, method 900 is performed as part of a process that forms an optical device, such as a PIC. Method 900 is described in the context of providing a single device. However, multiple devices may be fabricated together (e.g., in parallel).

Electrode(s) used to carry the electrode signals for electro-optically modulating the optical signal are provided, at 902. In some embodiments, 902 occurs after 904, described below. 902 may also occur after providing cladding and/or other components of the TFLC optical device. At least a portion of the electrodes provided at 902 are proximate to the waveguide(s) in the modulation sections(s). In some embodiments, 902 includes providing vias and delay sections that are electrically coupled to the electrodes in the modulation section(s).

At least one TFLC waveguide is fabricated, at 904. Providing each waveguide at 904 further includes providing at least one mode multiplexer, at least one modulation section, at least one mode converting reflector, and waveguide arms that are part of the modulator. The modulation section is positioned between and proximate to a portion of the electrode(s) and located in an optical path between the mode multiplexer and the mode converting reflector. The mode multiplexer is configured to propagate a first mode from a first waveguide arm to the modulation section, to receive a second mode from the modulation section, and to provide the first mode to a second waveguide arm based on the second mode received from the modulation section. The mode converting reflector is configured to receive the first mode from the modulation section and to propagate the second mode back through the modulation section. In some embodiments, the multiple waveguides provided at 904 are coupled via a splitter and/or combiner.

For example, in some embodiments, 902 includes providing electrodes 120 and 130. 904 includes providing waveguide 110. Thus, 904 includes providing mode multiplexer 150, waveguide arms 112 and 114, modulation section(s) 160, and mode converting reflector 170. In some embodiments, 902 includes providing electrodes 420, 430, and 440. In such an embodiment, 904 includes providing waveguides 410A and 410B. Thus, mode multiplexers 450A and 450B, modulation sections 460A and 460B, mode converting reflectors 470A and 470B, and waveguide arms 412A, 412B, 414A, and 414B are provided. In addition, splitter 480 and combiner 482 are provided. Optical modulators analogous to optical modulators 100, 100’, 200, 300, 400, 500, 600, and/or 700 may be provided using method 900. Thus, the benefits described herein may be achieved.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. An optical modulator, comprising:
at least one electrode; and
a waveguide including
a mode multiplexer;
a modulation section, the modulation section being between and proximate to a portion of the at least one electrode; and
a mode converting reflector, the modulation section being in an optical path between the mode multiplexer and the mode converting reflector, the mode multiplexer being configured to propagate a first mode from a first waveguide arm to the modulation section, to receive a second mode from the modulation section, and to provide the first mode to a second waveguide arm from the second mode received from the modulation section, the mode converting reflector being configured to receive the first mode from the modulation section and to propagate the second mode back through the modulation section.

2. The optical modulator of claim 1, wherein the first mode and the second mode are traveling wave modes.

3. The optical modulator of claim 1, wherein the waveguide further includes:
an additional mode multiplexer;
an additional modulation section, the additional modulation section being between and proximate to an additional portion of the at least one electrode; and
an additional mode converting reflector, the additional modulation section being in an additional optical path between the additional mode multiplexer and the additional mode converting reflector, the additional mode multiplexer being configured to propagate a third mode from a third waveguide arm to the additional modulation section, to receive a fourth mode from the additional modulation section, and to provide the third mode to a fourth waveguide arm from the fourth mode received from the additional modulation section, the additional mode converting reflector being configured to receive the third mode from the additional modulation section and to propagate the fourth mode back through the additional modulation section.

4. The optical modulator of claim 3, further comprising:
a splitter configured to split an input optical signal to the first mode in the first waveguide arm and the third mode in the third waveguide arm; and
a combiner for combining the second mode of the second waveguide arm with the fourth mode of the fourth waveguide arm.

5. The optical modulator of claim 4, wherein the first mode and the third mode are TE0 modes and the second mode and the fourth mode are TE1 modes.

6. The optical modulator of claim 3, the waveguide further comprising:
a third mode multiplexer, a third modulation section, and a third mode converting reflector coupled with the second waveguide arm, the third modulation section being between and proximate to a third portion of the at least one electrode; and
a fourth mode multiplexer, a fourth modulation section and a fourth mode converting reflector coupled with the fourth waveguide arm, the fourth modulation section being between and proximate to a fourth portion of the at least one electrode;
wherein the third mode multiplexer is configured to propagate the first mode from the second waveguide arm to the third modulation section, to receive the second mode from the third modulation section, and to provide the first mode to a fifth waveguide arm from the second mode from the third modulation section, the third mode converting reflector is configured to receive the first mode from the third modulation section and to propagate the second mode back through the third modulation section to the third mode multiplexer, the fourth mode multiplexer is configured to propagate the first mode from the fourth waveguide arm to the fourth modulation section, to receive the second mode from the fourth modulation section, and to provide the first mode to a sixth waveguide arm from the second mode from the fourth modulation section, the fourth mode converting reflector being configured to receive the first mode from the fourth modulation section and to propagate the second mode back through the fourth modulation section to the fourth mode multiplexer.

7. The optical modulator of claim 1, further comprising:
an electrode signal delay matching section coupled with the at least one electrode and configured to reduce a velocity mismatch between an electrode signal and an optical signal including the first mode and the second mode.

8. The optical modulator of claim 1, further comprising:
an electrode signal filtering network coupled with the at least one electrode.

9. The optical modulator of claim 1, wherein the waveguide includes lithium.

10. The optical modulator of claim 1, wherein the mode multiplexer is selected from an adiabatic mode multiplexer and a grating mode multiplexer.

11. The optical modulator of claim 1, wherein the optical modulator is a cascaded modulator including a plurality of stages; and
wherein a stage of the plurality of stages includes the mode multiplexer, the modulation section, and the mode converting reflector.

12. The optical modulator of claim 11, wherein the stage has a length of at least one hundred micrometers and not more than one millimeter.

13. An optical device, comprising:
an optical modulator including a plurality of electrodes and a waveguide, the waveguide including a mode multiplexer, at least one modulation section, and a mode converting reflector, the at least one modulation section being between and proximate to a portion of the plurality of electrodes, the at least one modulation section being in an optical path between the mode multiplexer and the mode converting reflector, the mode multiplexer being configured to propagate a first mode from a first waveguide arm to the at least one modulation section, to receive a second mode from the at least one modulation section, and to provide the first mode to a second waveguide arm from the second mode received from the at least one modulation section, the mode converting reflector being configured to receive the first mode from the at least one modulation section and to propagate the second mode back through the at least one modulation section.

14. The optical device of claim 13, wherein the waveguide further includes:
an additional mode multiplexer;
at least one additional modulation section, the at least one additional modulation section being between and proximate to an additional portion of the plurality of electrodes; and
an additional mode converting reflector, the at least one additional modulation section being in an additional optical path between the additional mode multiplexer and the additional mode converting reflector, the additional mode multiplexer being configured to propagate a third mode from a third waveguide arm to the at least one additional modulation section, to receive a fourth mode from the at least one additional modulation section, and to provide the third mode to a fourth waveguide arm from the fourth mode received from the at least one additional modulation section, the additional mode converting reflector being configured to receive the third mode from the at least one additional modulation section and to propagate the fourth mode back through the at least one additional modulation section.

15. The optical device of claim 14, wherein the optical modulator further includes:
a splitter configured to split an input optical signal to the first mode in the first waveguide arm and the third mode in the third waveguide arm; and
a combiner for combining the second mode of the second waveguide arm with the fourth mode of the fourth waveguide arm.

16. The optical device of claim 13, wherein the optical modulator further includes:
an electrode signal delay matching section coupled with the plurality of electrodes and configured to reduce a velocity mismatch between an electrode signal and an optical signal including the first mode and the second mode.

17. The optical device of claim 13, wherein the optical modulator further includes:
an electrode signal filtering network coupled with the plurality of electrodes.

18. The optical device of claim 13, wherein the optical modulator is a cascaded modulator including a plurality of stages; and
wherein a stage of the plurality of stages includes the mode multiplexer, the modulation section, and the mode converting reflector.

19. A method, comprising:
providing an optical modulator, the providing the optical modulator further including:
providing at least one electrode; and
providing a waveguide, the providing the waveguide further including
providing a mode multiplexer, a modulation section, and a mode converting reflector, the modulation section being between and proximate to a portion of the at least one electrode, the modulation section being in an optical path between the mode multiplexer and the mode converting reflector, the mode multiplexer being configured to propagate a first mode from a first waveguide arm to the modulation section, to receive a second mode from the modulation section, and to provide the first mode to a second waveguide arm from the second mode received from the modulation section, the mode converting reflector being configured to receive the first mode from the modulation section and to propagate the second mode back through the modulation section.

20. The method of claim 19, wherein the providing the waveguide further includes:
providing an additional mode multiplexer, an additional modulation section, and an additional mode converting reflector, the additional modulation section being between and proximate to an additional portion of the at least one electrode, the additional modulation section being in an additional optical path between the additional mode multiplexer and the additional mode converting reflector, the additional mode multiplexer being configured to propagate a third mode from a third waveguide arm to the additional modulation section, to receive a fourth mode from the additional modulation section, and to provide the third mode to a fourth waveguide arm from the fourth mode received from the additional modulation section, the additional mode converting reflector being configured to receive the third mode from the additional modulation section and to propagate the fourth mode back through the additional modulation section.
